(19) United States
(12) Patent Application Publication
(10) Pub. No.: US 2013/0253726 A1
(43) Pub. Date: Sep. 26, 2013

(54) APPARATUS MANAGEMENT SYSTEM, AND MOBILE TERMINAL WHICH IS USED IN APPARATUS MANAGEMENT SYSTEM

(71) Applicants: Yoshifumi Murakami, Osaka (JP); Toru Shimotsuma, Osaka (JP); Hiroki Kazuno, Osaka (JP); Toshiaki Nakao, Osaka (JP)

(72) Inventors: Yoshifumi Murakami, Osaka (JP); Toru Shimotsuma, Osaka (JP); Hiroki Kazuno, Osaka (JP); Toshiaki Nakao, Osaka (JP)

(73) Assignee: PANASONIC CORPORATION, Osaka (JP)

(21) Appl. No.: 13/991,455

(22) PCT Filed: Dec. 21, 2011
(86) PCT No.: PCT/JP2011/079679

§ 371 Date: Jun. 4, 2013

(30) Foreign Application Priority Data
Dec. 21, 2010 (JP) 2010-284644

(51) Int. Cl. G06F 1/26

(52) U.S. Cl. CPC G06F 1/26
USPC 700/297

(57) ABSTRACT

The apparatus management system includes a plurality of environmental control apparatuses, a power supply regulation device and a mobile terminal. Each of the environmental control apparatuses is assigned first identification information for physically distinguishing and logical second identification information. The power supply regulation device regulates the respective power supply to the environmental control apparatuses according to apparatus operation information. The mobile terminal includes a terminal-side storage section for storing a conversion table indicative of the correspondence between the first identification information and the second identification; and a conversion section for extracting, from the conversion table, the second identification information corresponding to the inputted first identification information. The mobile terminal includes an apparatus operation setting section for setting the apparatus operation information in association with the second identification information; and a terminal-side communication section for transmitting the apparatus operation information to the power supply regulation device via wireless communication.

### TECHNICAL FIELD

The invention relates to an apparatus management system for managing a plurality of environmental control apparatuses, and a mobile terminal used in the apparatus management system.

### BACKGROUND ART

Due to global warming, social need about energy-saving has been more increased in recent years. For example, Energy Saving Act (Act on the Rational Use of Energy) established in Japan demands that the civilian sector tries to not only improve the performance of an environmental control apparatus but promote the energy-saving from the side of the management of the apparatuses e.g. by using BEMS (Building Energy Management System). As the energy-saving method of the management side, a method of improving an operation schedule of the environmental control apparatuses has been known.

With regard to this, there has been known an apparatus management system configured to set an operation schedule of environmental control apparatuses (see e.g. JP8-50501A). The operation schedule includes operation contents of the environmental control apparatuses.

Further, in a system which includes a display for displaying an operation schedule, the system may be configured to, when the operation schedule is modified for improving the energy-saving effect, differentiate the color of a region corresponding to the modified part of the operation schedule to visualize the energy-saving effect. Such the system can improve a direct understanding of a manager about the operation management, and can help the manager to improve the management.

The operation contents are set through a tuning-process for promoting the energy-saving, which is performed on a field site on which the environmental control apparatuses are arranged. As an example of the tuning-process performed on the field site, a field engineer determines the operation contents of the environmental control apparatuses in consideration of working contents of workers in an area on which the environmental control apparatus is installed, and then sets the operation schedule of the environmental control apparatuses which reflects the operation contents. By virtue of this method for setting the operation schedule, energy-saving can be promoted with using an existing apparatus management system.

For example, in a foods supermarket, the tuning-process may be performed as the following steps. The foods supermarket generally is equipped with a plurality of lighting circuits for lighting apparatuses. Firstly, a field engineer verifies working contents and working hours of workers (working staffs) of the foods supermarket. Next, the field engineer turns on and off the lighting circuits in turn, and asks the workers e.g. whether it may cause some trouble in their work when only the lighting apparatuses related to a single lighting circuit are turned on. Then, the field engineer determines the operation schedule in consideration of working schedules of the workers and the brightness of the area. After determined the operation schedule, the lighting apparatuses are controlled in accordance with the determined operation schedule. As described above, the core of the tuning-process for promoting the energy-saving is, to verify the usage situation of the area; the lighting pattern for securing a required lighting intensity; and the working schedules of the workers, and to determine the operation schedule in consideration of the above points verified in the field site. By performing such the tuning-process, the operation schedule can be adjusted suitably for each field site.

However, in the conventional apparatus management system, a management device for setting the operation schedule is installed at a place different from the field site. Therefore, a field engineer is required to record the information about the operation schedule at the field site, and then to move to another place in order to make the configuration of the operation schedule. The information about the operation schedule should be recorded on a notebook or remembered by the field engineer. Therefore, it has been difficult to adjust the operation schedule in detail if information amount increase.

In addition, with regard to the abovementioned apparatus management system, usually, construction of electrical circuits for supplying power from a power source to the environmental control apparatuses and construction of system configuration for controlling the environmental control apparatuses are implemented by different contractors. Therefore, there is no relative rule between “circuit number (physical address)” allocated for the electric circuit distributed from a distribution board and “identification information (logical address)” used for the control of the environmental control apparatus, and they have no particular relationship. Then, a field engineer receives an assignment graph of physical address shown in FIG. 5A from an electric engineering constructor constructing the electric circuit, and receives an assignment graph of logical address shown in FIG. 5B from a system constructor constructing the system configuration (e.g. “HBXX” in FIG. 5A denotes a physical address, and “XX-X” in FIG. 5B denotes a logical address). Therefore, when setting an operation schedule, the field engineer is required to read the physical address of the environmental control apparatus and to convert the physical address into the corresponding logical address, using the assignment graph of physical address and the assignment graph of logical address. Such a process decreases the efficiency of the tuning-process, and becomes great burden on the field engineer having not enough time for the tuning-process.

### DISCLOSURE OF INVENTION

The present invention is developed in view of the above problem, and the object of the invention is to provide an apparatus management system that can reduce the burden on a field engineer when setting an operation schedule of environmental control apparatuses, and to provide a mobile terminal used in the apparatus management system.

An apparatus management system of the invention includes: a plurality of environmental control apparatuses configured to control an environment of a certain area; a power supply regulation device configured to regulate the respective power supply to the plurality of environmental control apparatuses via communication; and a portable type mobile terminal configured to be capable of communicating with the power supply regulation device, wherein each of the plurality of environmental control apparatuses is assigned first identification information for physically distinguishing the plurality of environmental control apparatuses and is assigned second identification information as logical information used for the communication between the environmental control apparatus and the power supply regulation device, wherein the power supply regulation device comprises: a receiving section configured to receive apparatus operation information from the mobile terminal via wireless communication, the apparatus operation information associating an operation content of each of the plurality of environmental control apparatuses with corresponding second identification information; an operation schedule modification section configured to modify an operation schedule of each of the plurality of environmental control apparatuses by using the apparatus operation information; and a supply regulation section configured to regulate the respective power supply to the plurality of environmental control apparatuses according to the apparatus operation information by using the second identification information, and wherein the mobile terminal comprises: an input section into which the first identification information is inputted; a terminal-side storage section configured to store a conversion table indicative of a correspondence between the first identification information and the second identification information; a conversion section configured to extract, from the conversion table, the second identification information corresponding to the inputted first identification information; an apparatus operation setting section configured to set the apparatus operation information in association with the second identification information extracted by the conversion section; and a transmission section configured to transmit the apparatus operation information set by the apparatus operation setting section to the power supply regulation device via the wireless communication.

In the apparatus management system, it is preferred that the first identification information is location information of the environmental control apparatus.

In the apparatus management system, it is preferred that the input section is configured that the location information of the environmental control apparatus is inputted into the input section through a graphical user interface.

In the apparatus management system, it is preferred that the apparatus management system further includes a sensor device for sensing an environmental condition of the area, and wherein the mobile terminal comprises a device-side storage section configured to store the environmental condition sensed by the sensor device in association with the apparatus operation information.

In the apparatus management system, it is preferred that the device-side storage section is configured to store additional information in association with the apparatus operation information.

In the apparatus management system, it is preferred that wherein the plurality of environmental control apparatuses include a plurality of lighting apparatuses, and wherein the supply regulation section is configured to regulate the respective power supply to the plurality of lighting apparatuses according to the apparatus operation information, thereby controlling an on/off state and light intensity of each of the plurality of lighting apparatuses.

In the apparatus management system, it is preferred that wherein the plurality of environmental control apparatuses include a plurality of air-conditioning apparatuses, and wherein the supply regulation section is configured to regulate the respective power supply to the plurality of air-conditioning apparatuses according to the apparatus operation information, thereby controlling an on/off state and a preset temperature of each of the plurality of air-conditioning apparatuses.

According to the invention, a field engineer can set, with staying on the field site, the apparatus operation information including the operation contents of the environmental control apparatuses. In addition, even if the field engineer does not know the second identification information which is used when the power supply regulation device controls the environmental control apparatus, the mobile terminal allows the field engineer to set the apparatus operation information of each environmental control apparatus just by checking in the field site the first identification information allocated for the power supply path. This configuration therefore can reduce the burden on the field engineer when the field engineer sets the operation schedule of the environmental control apparatus.

### BRIEF DESCRIPTION OF DRAWINGS

FIG. 1 is a block diagram showing a configuration of an apparatus management system according to an embodiment;

FIG. 2 shows a conversion table stored in a mobile terminal according to the embodiment;

FIG. 3 is an appearance view of the mobile terminal according to the embodiment;

FIG. 4 includes FIGS. 4A and 4B, where FIG. 4A is an illustration view of the mobile terminal according to the embodiment in which additional information is displayed and FIG. 4B is an illustration view of the mobile terminal according to the embodiment in which environmental condition of areas are displayed; and

FIG. 5 includes FIGS. 5A and 5B, where FIG. 5A shows an example of an assignment graph of physical address prepared by an electric engineering constructor, and FIG. 5B shows an example of an assignment graph of logical address prepared by a system constructor.

### DESCRIPTION OF THE INVENTION

In the following, an embodiment of an apparatus management system for managing a plurality of environmental control apparatuses is described. In the embodiment, “monitoring” the operation conditions of the environmental control apparatuses and “controlling” the environmental control apparatuses are referred to as “managing” the environmental control apparatuses. Therefore, “management” of the environmental control apparatuses indicates at least one of “monitoring” and “control” of the environmental control apparatuses.

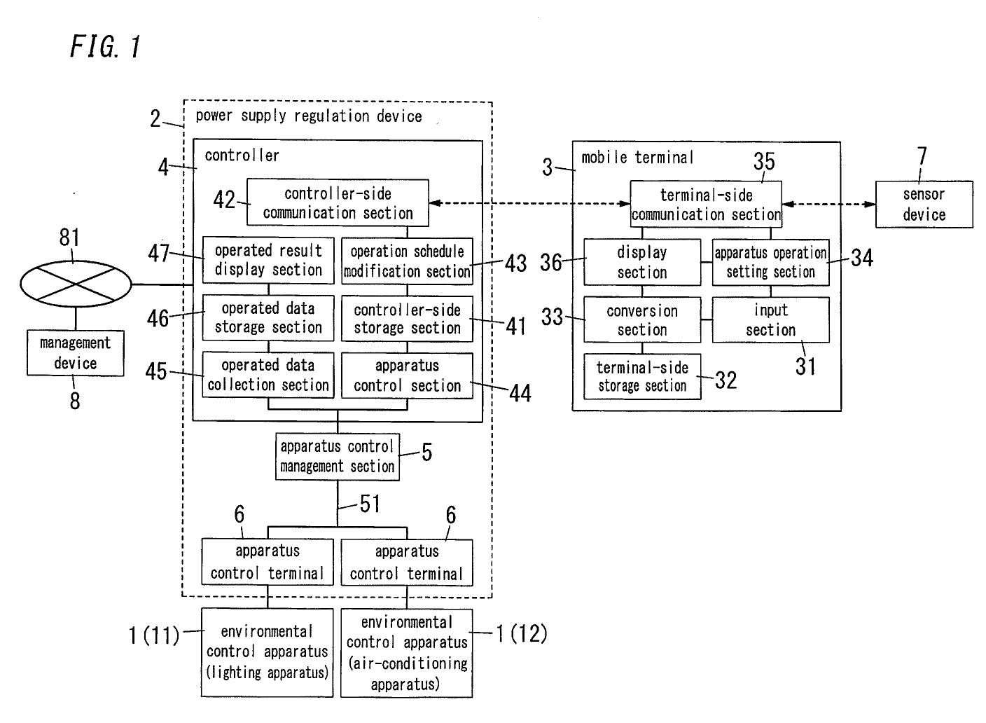

As shown in FIG. 1, the apparatus management system of the embodiment includes environmental control apparatuses 1 configured to control an environment of a certain area and a power supply regulation device 2 configured to regulate the power supply to the environmental control apparatuses 1 via communication. The apparatus management system of the embodiment further includes a portable type mobile terminal 3 capable of communicating with the power supply regulation device 2.

The environmental control apparatus 1 is an apparatus designed for adjusting e.g. lighting environment of the area or air-condition of the area. Examples of the environmental control apparatuses 1 of the embodiment include a lighting apparatus 11 for controlling the brightness in the area and an air-conditioning apparatus 12 for controlling the temperature in the area. In other words, examples of the environments of the area controlled by the environmental control apparatus 1 of the embodiment include the brightness in the area and the temperature in the area. For example, the lighting apparatus 11 shown in FIG. 1 may include a plurality of lighting apparatuses 11 as a plurality of environmental control apparatuses 1. For example, the air-conditioning apparatus 12 shown in FIG. 1 may include a plurality of air-conditioning apparatuses 12 as a plurality of environmental control apparatuses 1. Electric circuits (not shown) for the distribution of electricity from a power source (not shown) to the environmental control apparatuses 1 are provided in the area. A relay device (not shown) is connected between the power source and the environmental control apparatus 1.

Each of the environmental control apparatuses 1 is assigned first identification information for physically distinguishing the environmental control apparatuses 1. For example, the environmental control apparatuses 1 related to different power supply paths are assigned different physical addresses (e.g. physical address may be a circuit number allocated for each circuit distributed from a distribution board). Each of the environmental control apparatuses 1 is assigned second identification information as logical information used for the communication between the environmental control apparatus 1 and the power supply regulation device 2. That is, each of the environmental control apparatuses 1 is assigned a logical address (second identification information) used by the power supply regulation device 2, in addition to a physical address (first identification information).

Each of the environmental control apparatuses 1 may be assigned location information (e.g. place name on which the environmental control apparatus 1 is installed), with respect to each power supply path. Each location information assigned to the environmental control apparatus 1 may correspond one-to-one with a physical address (e.g. circuit number allocated for each circuit distributed from a distribution board) each assigned to the environmental control apparatus 1. As described above, each of the environmental control apparatuses 1 is assigned the logical second identification information used for the communication between the environmental control apparatus 1 and the power supply regulation device 2. That is, each of the environmental control apparatuses 1 is assigned a logical address (second identification information) used by the power supply regulation device 2, in addition to location information (first identification information).

The mobile terminal 3 is in the form of such as a tablet type personal computer as shown in FIG. 3, and equipped with a CPU (Central Processing Unit) and a memory. The mobile terminal 3 includes an input section 31, a terminal-side storage section 32, a conversion section 33, an apparatus operation setting section 34, a terminal-side communication section (transmission section) 35, and a display section 36, as shown in FIG. 1.

The input section 31 is used when a field engineer inputs information into the mobile terminal 3. For example, the first identification information is inputted to the input section 31. In the embodiment, the location information of the environmental control apparatus 1 may be inputted through a graphical user interface, or the physical address may be inputted, into the input section 31.

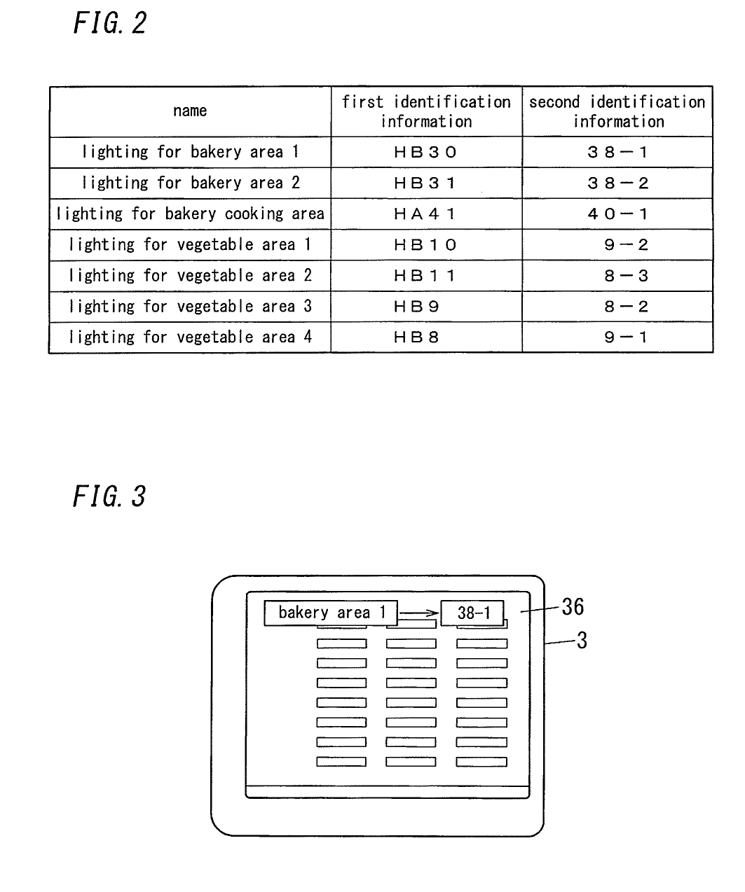

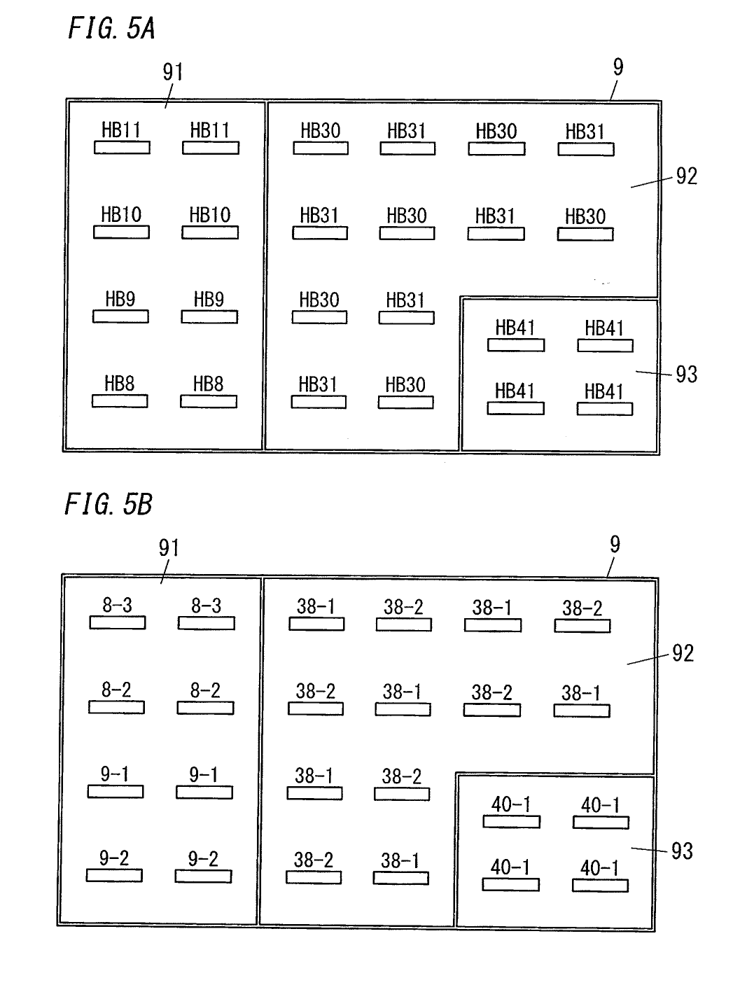

The terminal-side storage section 32 is configured to store a conversion table indicative of the correspondence between the first identification information and the second identification information. FIG. 2 shows a conversion table related to the lighting apparatuses 11. The conversion table indicates the correspondence between “area name”, “first identification information” and “second identification information”. The conversion table is preliminarily prepared using e.g. the assignment graph of physical address shown in FIG. 5A and the assignment graph of logical address shown in FIG. 5B. Note that, the terminal-side storage section 32 is configured to store a conversion table for the air-conditioning apparatuses 12, too, which is represented in a similar format with that for the lighting apparatus 11.

For example, in a case where it is designed that the physical address (e.g. circuit number allocated for each circuit distributed from a distribution board) of the environmental control apparatus 1 is used as the first identification information inputted into the input section 31, the terminal-side storage section 32 stores a conversion table indicative of the correspondence between the physical address and the second identification information.

For example, in a case where it is designed that the location information of the environmental control apparatus 1 is used as the first identification information inputted into the input section 31, the terminal-side storage section 32 stores a conversion table indicative of the correspondence between the location information and the second identification information. In this case, the terminal-side storage section 32 may store both first and second conversion tables, where the first conversion table is indicative of the correspondence between the physical address and the second identification information, and the second conversion table is indicative of the correspondence between the location information and the physical address.

The conversion section 33, which is shown in FIG. 1, is configured to extract second identification information which corresponds to the inputted first identification information (e.g. location information or physical address) from the conversion table in the terminal-side storage section 32. That is, the conversion section 33 is configured to convert the first identification information into the second identification information using the conversion table stored in the terminal-side storage section 32.

The apparatus operation setting section 34 is configured to set apparatus operation information in association with the second identification information extracted by the conversion section 33. The apparatus operation information is information indicative of the correspondence between an operation content of the environmental control apparatus 1, the second identification information, and the time (or time period) at which the operation content is executed.

The apparatus operation information may include information related to a single environmental control apparatus 1, or may include information related to a plurality of environmental control apparatuses 1 (e.g. may include information related to all of environmental control apparatuses 1 installed in the area). In a case where the apparatus operation information includes the information related to a plurality of environmental control apparatus 1, the apparatus operation information may include information indicative of the correspondences between the operation content, the second identification information, and the time at which the operation content is executed, about respective environmental control apparatuses 1.

In a case where the environmental control apparatus 1 is the lighting apparatus 11, examples of the operation contents of the environmental control apparatus 1 include the on/off state of the lighting apparatus 11 and the light intensity of the lighting apparatus 11. In a case where the environmental control apparatus 1 is the air-conditioning apparatus 12, examples of the operation contents of the environmental control apparatus 1 include the on/off state of the air-conditioning apparatus 12 and the preset temperature of the air-conditioning apparatus 12.

The terminal-side communication section 35 is configured to transmit and receive information to and from the power supply regulation device 2 via wireless communication. Specifically, the terminal-side communication section 35 is configured to transmit the apparatus operation information set by the apparatus operation setting section 34 to the power supply regulation device 2 via the wireless communication.

The display section 36 is in the form of a liquid crystal display, an organic EL (Electro-Luminescence) display, or the like. For example, the assignment graph of physical address, the apparatus operation information set by the apparatus operation setting section 34 and the like can be displayed on the display section 36. The second identification information converted by the conversion section 33 can be displayed on the display section 36 together with the first identification information. Furthermore, information obtained from the power supply regulation device 2 through the terminal-side communication section 35 can be displayed on the display section 36. For example, an operation schedule (described later) obtained from the power supply regulation device 2 can be displayed on the display section 36.

The power supply regulation device 2 includes a controller 4, an apparatus control management section 5, and a plurality (two in the illustrated example) of apparatus control terminals 6.

The controller 4 is mainly composed of a computer equipped with a CPU and a memory. The controller 4 is configured to instruct the operation of the environmental control apparatuses 1, to collect information about the operation conditions of the environmental control apparatuses 1 and the like. The controller 4 includes a controller-side storage section 41, a controller-side communication section (receiving section) 42, an operation schedule modification section 43, and an apparatus control section 44.

The controller-side storage section 41 is configured to store the operation schedule in which an operation content of each environmental control apparatus 1 is associated with corresponding second identification information and time information. For example, the operation schedule stored in the controller-side storage section 41 is indicative of the correspondences between the operation content, the second identification information and the time information, with regard to respective environmental control apparatuses 1. The operation schedule is configured to transmit the on/off command etc. to the apparatus control terminals 6 and relay devices (not shown) provided in the electric circuits adapted for the distribution of electricity from the power source to the environmental control apparatuses 1.

The controller-side communication section 42 is configured to transmit and receive information to and from the mobile terminal 3 via the wireless communication. Specifically, the controller-side communication section 42 is configured to receive the apparatus operation information from the mobile terminal 3 via the wireless communication.

The operation schedule modification section 43 is configured to modify the operation schedule based on the apparatus operation information received by the controller-side communication section 42. For example, the operation schedule modification section 43 may be configured to replace the current operation schedule with the apparatus operation information received by the controller-side communication section 42, thereby modifying the operation schedule. The modified operation schedule is stored in the controller-side storage section 41.

The apparatus control section 44 is configured to output, a control signal for regulating the power supply to the environmental control apparatus 1, to the apparatus control management section 5, according to the operation schedule stored in the controller-side storage section 41. The control signal includes information about the operation content(s of one or more) of the environmental control apparatus(es) 1.

The apparatus control management section 5 and each of the apparatus control terminals 6 are connected to a communication network. In the communication network, a fixed-length transmission signal according to time-division multiplex method is transmitted through a two-wire type signal line 51. The apparatus control management section 5 is configured to periodically transmit the fixed-length transmission signal onto the signal line 51. Each of the apparatus control terminals 6 is connected to a corresponding environmental control apparatus 1.

The apparatus control management section 5 is mainly composed of a computer equipped with a CPU and a memory. The apparatus control management section 5 is configured to transfer the control signal received from the apparatus control section 44 into a desired apparatus control terminal 6.

After receiving the control signal, the apparatus control terminal 6 may turn on and off the relay device (not shown) provided in the electric circuit for the distribution of electricity from the power source to the environmental control apparatus 1 if the control signal includes such the operation content. With this way, the operation of the environmental control apparatus 1 can be modified. In addition, the apparatus control terminal 6 is configured to modify the setting of the environmental control apparatus 1. In a case where the environmental control apparatus 1 is the lighting apparatus 11, the apparatus control terminal 6 can be configured to control the dimming level of the lighting apparatus 11. In a case where the environmental control apparatus 1 is the air-conditioning apparatus 12, the apparatus control terminal 6 can be configured to control the preset temperature of the air-conditioning apparatus 12.

In short, the apparatus control section 44 of the controller 4, the apparatus control management section 5 and the apparatus control terminals 6 regulate the power supply to the environmental control apparatuses 1 according to the apparatus operation information using the second identification information (i.e. according to the operation schedule set based on the apparatus operation information). The apparatus control section 44, the apparatus control management section 5 and the apparatus control terminals 6 are regarded as a “supply regulation section”.

Furthermore, in the present embodiment, when the controller-side communication section 42 of the controller 4 receiving the apparatus operation information from the mobile terminal 3, the power supply regulation device 2 (the controller 4, the apparatus control management section 5 and the apparatus control terminals 6) regulates the power supply to the environmental control apparatuses 1 according to the operation contents included in the apparatus operation information. That is, the power supply regulation device 2 can modify the current operations of the environmental control apparatuses 1 in accordance with the operation contents set by the mobile terminal 3. For example, the mobile terminal 3 may be configured to set the execution time of the operation content (included in the apparatus operation information) at “the current time”, thereby modifying the current operation of the environmental control apparatus 1. Or else, when modifying the current operation, the mobile terminal 3 may transmit an apparatus operation information of another format (e.g. which includes only the second identification information and the operation content of the environmental control apparatus 1) to the controller-side communication section 42, instead of transmitting the above-described apparatus operation information (which includes the operation content of the environmental control apparatus 1, the second identification information, and the time for executing the operation content) for modifying the operation schedule. In this case, when receiving the apparatus operation information of another format, the power supply regulation device 2 modifies the current operation of the environmental control apparatuses 1 (identified by the apparatus operation information) according to the apparatus operation information. With such the configurations, a field engineer can adjust and set the operation schedule of the environmental control apparatuses 1, with actually changing the current operations of the environmental control apparatuses 1 in the field site by transmitting the operation contents to the controller 4 from the mobile terminal 3 during the tuning-process.

The apparatus management system of the embodiment further includes a sensor device 7 configured to sense an environmental condition of the area. In the embodiment, examples of the environmental conditions of the area include the brightness of the area and the temperature of the area. The brightness of the area may be e.g. luminance or brilliance of the area.

Examples of the sensor devices 7 include a brightness sensor for sensing the brightness of the area and a temperature sensor for sensing the temperature of the area. The brightness sensor may be e.g. a luminance sensor or a brilliance sensor. The apparatus management system of the embodiment may include another sensor (e.g. a humidity sensor) as the sensor device 7.

The terminal-side communication section 35 of the mobile terminal 3 is configured to transmit and receive information to and from the sensor device 7 via wireless communication. Specifically, the terminal-side communication section 35 is configured to receive the sensing result of the sensor device 7 from the sensor device 7 via the wireless communication.

The terminal-side storage section 32 of the mobile terminal 3 is configured to store the sensing result (i.e. environmental condition sensed by the sensor device 7) received by the terminal-side communication section 35 in association with the apparatus operation information. For example, the terminal-side storage section 32 is configured to store the information about the environmental condition (e.g. brightness of the area when the environmental control apparatus 1 is the lighting apparatus 11) controlled by the environmental control apparatus 1 in association with the current operation content of the environmental control apparatus 1. Note that, in the embodiment, the terminal-side storage section 32 serves as a device-side storage section which is configured to store the environmental condition sensed by the sensor device 7 in association with the apparatus operation information. Furthermore, the terminal-side storage section 32 is configured to store additional information in association with the apparatus operation information. Examples of the additional information include arrangement information of the environmental control apparatus 1, information about the sensing position of the sensor device 7, the environmental condition sensed by the sensor device 7, image data of the area, feedback and comment of a user stayed in the area and the like. Examples of the arrangement information of the environmental control apparatus 1 include information about the location where the environmental control apparatus 1 is arranged in the area, information about the intervals of the environmental control apparatuses 1 and the like. Examples of the information about the sensing position of the sensor device 7 include information about the location where the sensor device 7 is arranged in the area, information of the height of the location of the sensor device 7 and the like.

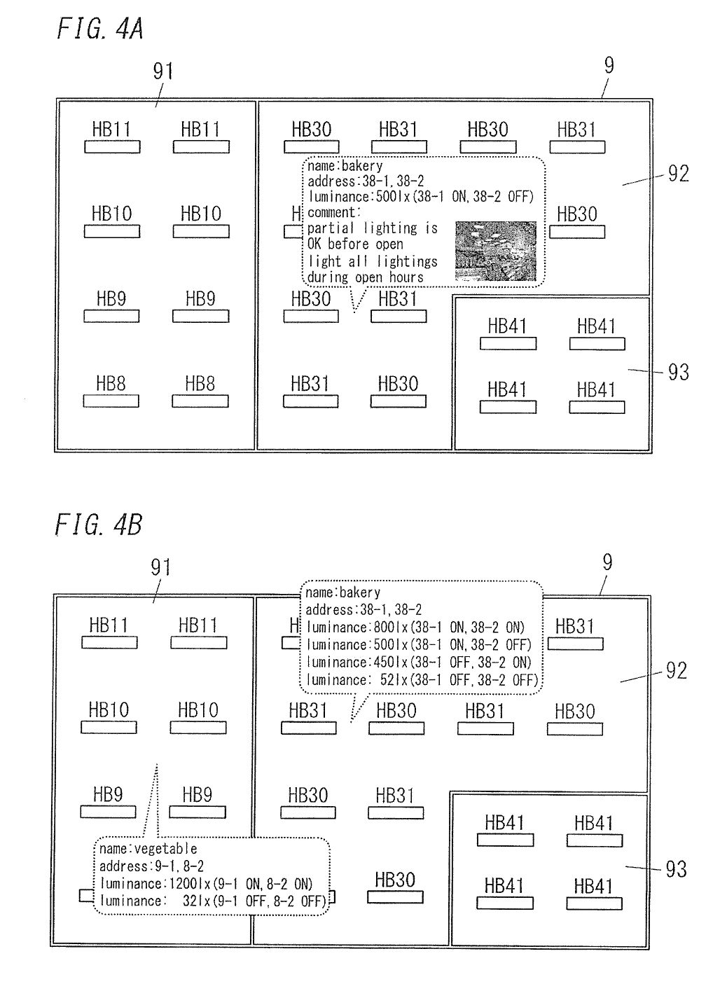

The display section 36 of the mobile terminal 3 can display the additional information as shown in FIG. 4A and the environmental condition sensed by the sensor device 7 as shown in FIG. 4B.

The mobile terminal 3 can store the additional information (such as the feedback of the user stayed in the area) in association with the apparatus operation information when e.g. modifying an operation content of an environmental control apparatus 1. With this configuration, the intended purpose of the area and the apparatus operation information can be related, and thereby the environmental control apparatus 1 can be controlled based on the operation content in consideration of the intended purpose. In a case where the environmental control apparatus 1 is the lighting apparatus 11, the mobile terminal 3 may store the condition of outside light (i.e. intensity of outside light) streamed through a window or the like, in association with the apparatus operation information. With this configuration, the operation content of the lighting apparatus 11 can be modified in consideration of the intensity of outside light. Therefore, the lighting apparatuses 11 can be partially lit (dimmed) when the intensity of outside light is high (e.g. time zone in which the outside light intensity is high), and thereby can improve the energy-saving effect.

Furthermore, because these information can be stored and displayed, a third person can quite obviously see the feedback (i.e. the information that can be obtained only in the field site, e.g. an opinion that the field is too dark, or an opinion that the lighting apparatuses should not be darkened during a time period in which a cutting machine is to be used, etc.) of the workers and reasoning of the setting of the operation schedule. Therefore, the information of the field site can be shared not only by the field engineer but a person who does not know the field site in detail.

When the values of the luminance of the field sensed under various conditions of the lighting apparatuses 11 are stored, tuning-process of the lighting apparatus can be performed appropriately. In addition, such information can be used as objectively quantitative information, therefore this information can be used as a reference when an operation schedule is set in a similar area.

The controller 4 shown in FIG. 1 includes an operated data collection section 45, an operated data storage section 46, and an operated result display section 47, in order to manage an operated data related to the actually operated status (operation condition) of each of the environmental control apparatuses 1.

The operated data collection section 45 is configured to request for the apparatus control management section 5 to obtain the operated data of the environmental control apparatus 1, and then obtain the operated data from the apparatus control management section 5. The operated data includes the information about the operation condition of the environmental control apparatus 1. The apparatus control management section 5 obtains the operation condition of the environmental control apparatus 1 from the apparatus control terminal 6 by way of monitoring the transmission signal. The operated data storage section 46 is configured to store the operated data obtained by the operated data collection section 45. The operated result display section 47 is configured to display the operation condition of the environmental control apparatus 1 using the operated data stored in the operated data storage section 46. The controller 4 has a function of transmitting the operated data to a management device 8 (which is described later).

The apparatus management system of the embodiment includes the management device 8 configured to manage the environmental control apparatuses 1. The management device 8 is connected with the controller 4 through a network 81 (e.g. the World Wide Web). The management device 8 is configured to request for the controller 4 to control the environmental control apparatuses 1, to obtain the operated data from the controller 4, and the like.

An example of how the apparatus management system of the embodiment is used will be described in the following.

In a case where the environmental control apparatuses 1 includes lighting apparatuses 11, the supply regulation section regulates the respective power supply to the lighting apparatuses 11 according to the apparatus operation information, thereby controlling an on/off state and light intensity of each of the lighting apparatuses 11.

In a case where the environmental control apparatuses 1 includes air-conditioning apparatus 12, the supply regulation section regulates the respective power supply to the air-conditioning apparatuses 12 according to the apparatus operation information, thereby controlling an on/off state and a preset temperature of each of the air-conditioning apparatuses 12.

In the example described below, it is assumed that each of the environmental control apparatus 1 is consisted by the lighting apparatus 11. Note that, such a case where the environmental control apparatus 1 is constituted by the air-conditioning apparatus 12 or the like can be understood similarly. In an exemplified foods supermarket 9 shown in FIG. 5A, a vegetable area 91 has four systems (HB8, HB9, HB10 and HB11 in FIG. 5A) of lighting circuits (physical addresses), a bakery area 92 has two systems (HB30 and HB31 in FIG. 5A) of lighting circuits, and a bakery cooking area 93 has one system (HB41) of lighting circuit. In the bakery area 92, the lighting apparatuses 11 of same system are arranged in a staggered (alternated) arrangement, as shown in FIG. 5A. This arrangement allows to darken the area by partially light the lighting apparatuses 11 (e.g. the lighting apparatuses 11 related to either one system can be turned off or dimmed) depending on working contents of workers.

A field engineer verifies working contents, working hours and working orders of workers (working staffs) in the bakery area 92. The field engineer then judges whether the current brightness of the area by the lighting apparatuses 11 is sufficient or not by e.g. visually, or using a sensing result of the sensor device 7 or a picture. After then, the field engineer alters the operation contents (lighting patterns) of the lighting apparatuses 11 by using the mobile terminal 3, and judges whether the brightness of the area is sufficient or not for the working content. When judging that the area is too bright, the field engineer properly dims the light (partially lights the lighting apparatuses 11) to determine a suitable operation content.

For example, if the lighting apparatuses 11 related to both systems (HB30 and HB31) in the bakery area 92 are turned on during the cleaning work in nighttime, the field engineer tries to turn on only the lighting apparatuses 11 related to one system (e.g. HB30) to darken the bakery area 92, and then assesses the validity of the brightness. At this time, since the mobile terminal 3 includes the input section 31 based on the graphical user interface and the conversion table, the field engineer can easily find the desired second identification information (e.g. 38-1) assigned to the lighting apparatus 11 of one system (e.g. HB30). That is, when the field engineer inputs first identification information (e.g. physical address or location information) into the input section 31, the conversion section 33 of the mobile terminal 3 extracts second identification information corresponding to the inputted first identification information from the conversion table of the terminal-side storage section 32. With this way, the field engineer can call up the desired second identification information (e.g. 38-1) only by inputting the intended first identification information (e.g. HB30). Or, the field engineer can display the conversion table indicative of the correspondence between the first identification information and the second identification information on the display section 36. With this way, the field engineer can easily call up the desired second identification information (e.g. 38-1) assigned to the lighting apparatus 11 of one system (e.g. HB30). Furthermore, because the picture of the area, and the information about the brightness of the area and the feedback and comment of workers can be stored in association with the apparatus operation information, a third person can easily understand the reasoning of the setting of the apparatus operation information when seeing the setting contents of the apparatus operation information.

After then, the supply regulation section (the apparatus control section 44, the apparatus control management section 5 and the apparatus control terminals 6) regulates the respective power supply to the lighting apparatuses 11 (the environmental control apparatuses 1) according to the operation schedule set by use of the mobile terminal 3.

An example of the operation schedule for the lighting apparatus 11 installed in the bakery area 92 is described bellow. For example, during the time period before open the foods supermarket 9 (e.g. from 8:00 a.m. to 9:00 a.m.), the lighting apparatuses 11 are controlled according to the operation contents (e.g. the lighting apparatuses related to the system HB30 are lit at rated power and the lighting apparatuses related to the system HB31 are turned off) confirmed by the workers (working staffs). During the open hours (e.g. from 9:00 a.m. to 8:00 p.m.), the lighting apparatuses 11 of all systems (HB30 and HB31) are controlled to light at rated power. During the time period for the cleaning work (e.g. from 8:00 p.m. to 10:00 p.m.), the lighting apparatuses 11 are controlled according to the operation contents (e.g. the lighting apparatuses related to the system HB30 are lit at three-fourth of the rated power and the lighting apparatuses related to the system HB31 are lit at the rated power) confirmed by the workers (working staffs). During closing the store (e.g. from 10:00 p.m. to 8:00 a.m.), the lighting apparatuses 11 of all systems (HB30 and HB31) are controlled to be turned off. The power supply regulation device 2 controls the environmental control apparatuses 1 according to the actually verified environmental condition by the field engineer in the area.

According to the apparatus management system of the embodiment, a field engineer can set, without leaving the field site, the apparatus operation information including the operation content of the environmental control apparatus 1. In addition, even if the field engineer does not know the second identification information which is used by the power supply regulation device 2, the field engineer can set the apparatus operation information of each environmental control apparatus 1 by use of the mobile terminal 3 with just checking in the field site the first identification information allocated for the power supplying path. The embodiment therefore can reduce the burden on the field engineer when the field engineer sets the operation schedule of the environmental control apparatus 1.

According to the apparatus management system of the embodiment, the location information of the environmental control apparatus 1 is used as the first identification information. With this configuration, the field engineer can make a setting of the apparatus operation information of the environmental control apparatus 1 and control of the environmental control apparatus 1 only by identifying the location of the environmental control apparatus 1. With this configuration, the field engineer can intuitively connect the operation condition of the environmental control apparatus 1 and his task, therefore the field engineer can perform his task easily and speedy.

In the apparatus management system of the embodiment, the location information of the environmental control apparatus 1 can be inputted into the input section 31 through the graphical user interface. With this configuration, the field engineer can associate the operation content set by the mobile terminal 3 with the second identification information only through a visual observation and a selection, therefore the field engineer can easily set the apparatus operation information of the environmental control apparatuses 1.

According to the apparatus management system of the embodiment, the environmental condition of the area can be sensed at the area and then stored in association with the apparatus operation information, therefore the apparatus operation information can be adjusted as appropriate.

The apparatus management system of the embodiment can assist the setting of the operation schedule for example by storing the feedback or comment after setting the apparatus operation information of the environmental control apparatus 1.

In a case where the environmental control apparatus 1 is the lighting apparatus 11, the operation contents of the plurality of lighting apparatuses 11 can be set by use of the mobile terminal 3 while verifying the brightness of the area. With this configuration, the operation schedule of the lighting apparatuses 11 can be determined while verifying the brightness required for the workers (working staffs), and therefore wasted electricity of the lighting apparatuses 11 can be reduced.

In a case where the environmental control apparatus 1 is the air-conditioning apparatus 12, the operation contents of the plurality of air-conditioning apparatuses 12 can be set by use of the mobile terminal 3 while verifying the temperature of the area. With this configuration, the operation schedule of the air-conditioning apparatuses 12 can be determined while verifying the environmental condition (temperature and/or humidity) required for the workers (working staffs), and therefore wasted electricity of the air-conditioning apparatuses 12 can be reduced.

As a modified example of the embodiment, the first identification information includes only the location information of the environmental control apparatus 1.

The location information is not limited to the place name for identifying the arrangement place of the environmental control apparatus 1, and may be information that can determine at least the arranged place of the environmental control apparatus 1. For example, overall view of the area may be displayed on the input section 31 of the graphical user interface, and arrangement places of the environmental control apparatuses 1 may be displayed by icons on the overall view of the area. In this configuration, the icons may be regarded as the location information.

The mobile terminal 3 may have a function of automatically generating the operation schedule based on an environment control pattern (e.g. lighting pattern or air-conditioning pattern) and a utilization pattern obtained by external information such as opinion of a user.

1. An apparatus management system comprising:
a plurality of environmental control apparatuses configured to control an environment of a certain area;
a power supply regulation device configured to regulate the respective power supply to the plurality of environmental control apparatuses via communication; and
a portable type mobile terminal configured to be capable of communicating with the power supply regulation device,
wherein each of the plurality of environmental control apparatuses is assigned first identification information for physically distinguishing the plurality of environmental control apparatuses and is assigned second identification information as logical information used for the communication between the environmental control apparatus and the power supply regulation device,
wherein the power supply regulation device comprises:
a receiving section configured to receive apparatus operation information from the mobile terminal via wireless communication, the apparatus operation information associating an operation content of each of the plurality of environmental control apparatuses with corresponding second identification information;
an operation schedule modification section configured to modify an operation schedule of each of the plurality of environmental control apparatuses by using the apparatus operation information; and
a supply regulation section configured to regulate the respective power supply to the plurality of environmental control apparatuses according to the apparatus operation information by using the second identification information, and
wherein the mobile terminal comprises:
an input section into which the first identification information is inputted;
a terminal-side storage section configured to store a conversion table indicative of a correspondence between the first identification information and the second identification information;
a conversion section configured to extract, from the conversion table, the second identification information corresponding to the inputted first identification information;
an apparatus operation setting section configured to set the apparatus operation information in association with the second identification information extracted by the conversion section; and
a transmission section configured to transmit the apparatus operation information set by the apparatus operation setting section to the power supply regulation device via the wireless communication.

2. The apparatus management system as set forth in claim 1, wherein the first identification information is location information of the environmental control apparatus.

3. The apparatus management system as set forth in claim 2, wherein the input section is configured that the location information of the environmental control apparatus is inputted into the input section through a graphical user interface.

4. The apparatus management system as set forth in claim 1, further comprising a sensor device configured to sense an environmental condition of the area,
wherein the mobile terminal comprises a device-side storage section configured to store the environmental condition sensed by the sensor device in association with the apparatus operation information.

5. The apparatus management system as set forth in claim 1, wherein the device-side storage section is configured to store additional information in association with the apparatus operation information.

6. The apparatus management system as set forth in claim 1,
wherein the plurality of environmental control apparatuses include a plurality of lighting apparatuses, and
wherein the supply regulation section is configured to regulate the respective power supply to the plurality of lighting apparatuses according to the apparatus operation information, thereby controlling an on/off state and light intensity of each of the plurality of lighting apparatuses.

7. The apparatus management system as set forth in claim 1,
wherein the plurality of environmental control apparatuses include a plurality of air-conditioning apparatuses, and
wherein the supply regulation section is configured to regulate the respective power supply to the plurality of air-conditioning apparatuses according to the apparatus operation information, thereby controlling an on/off state and a preset temperature of each of the plurality of air-conditioning apparatuses.

8. The mobile terminal used in the apparatus management system as set forth in claim 1.

9. The apparatus management system as set forth in claim 2, further comprising a sensor device configured to sense an environmental condition of the area,
wherein the mobile terminal comprises a device-side storage section configured to store the environmental condition sensed by the sensor device in association with the apparatus operation information.

10. The apparatus management system as set forth in claim 3, further comprising a sensor device configured to sense an environmental condition of the area,
wherein the mobile terminal comprises a device-side storage section configured to store the environmental condition sensed by the sensor device in association with the apparatus operation information.

11. The apparatus management system as set forth in claim 2, wherein the device-side storage section is configured to store additional information in association with the apparatus operation information.

12. The apparatus management system as set forth in claim 3, wherein the device-side storage section is configured to store additional information in association with the apparatus operation information.

13. The apparatus management system as set forth in claim 4, wherein the device-side storage section is configured to store additional information in association with the apparatus operation information.

14. The apparatus management system as set forth in claim 9, wherein the device-side storage section is configured to store additional information in association with the apparatus operation information.

15. The apparatus management system as set forth in claim 10, wherein the device-side storage section is configured to store additional information in association with the apparatus operation information.
